(19) United States
(12) Patent Application Publication
(10) Pub. No.: US 2021/0314826 A1
(43) Pub. Date: Oct. 7, 2021

(54) CONTROL METHOD FOR USER EQUIPMENT, AND USER EQUIPMENT

(71) Applicant: SHARP KABUSHIKI KAISHA, Sakai City, Osaka (JP)

(72) Inventors: NINGJUAN CHANG, Shanghai (CN); RENMAO LIU, Shanghai (CN); HIDEKAZU TSUBOI, Sakai City, Osaka (JP)

(21) Appl. No.: 17/263,417

(22) PCT Filed: Aug. 1, 2019
(86) PCT No.: PCT/CN2019/098848

§ 371 Date: Jan. 26, 2021

(30) Foreign Application Priority Data
Aug. 1, 2018 (CN) 201810867644.9

(51) Int. Cl. H04W 36/00; H04W 36/30; H04W 36/04

(52) U.S. Cl. CPC H04W 36/0058; H04W 36/04; H04W 36/305; H04W 36/0079

(57) ABSTRACT

The present disclosure provides a control method for user equipment and user equipment. The control method for user equipment (UE) includes: receiving, by the UE, a radio resource control (RRC) reconfiguration message from a base station; and if the RRC reconfiguration message includes radio link monitoring configuration information, if a fast handover failure recovery timer is running, stopping the fast handover failure recovery timer.

### TECHNICAL FIELD

The present disclosure relates to the technical field of wireless communications. More specifically, the present disclosure relates to a control method for user equipment and user equipment.

### BACKGROUND

A new research project on 5G technical standards (see non-patent literature: RP-181433: New WID on NR (New Radio) mobility enhancements) was approved in the 3rd Generation Partnership Project (3GPP) RAN#80 plenary session held in June 2018. One of the research objectives of this project is to meet one of the mobility requirements in NR: seamless handover, namely, to achieve a handover interruption time period of 0 millisecond in a cell handover procedure. Solutions under research for shortening a handover interruption time period include a solution referred to as fast handover failure recovery. That is, during a handover procedure, a radio link connection between user equipment (UE) and a network-side base station can quickly recover from a failed handover or a handover predicted to fail.

Research on a fast handover failure recovery solution in an NR system will be carried out based on a fast handover failure recovery solution in a Long Term Evolution (LTE) system. The present disclosure provides solutions related to implementing a fast handover failure recovery technology in the NR system.

### SUMMARY

The objective of the present disclosure is to provide solutions related to implementing a fast handover failure recovery technology in an NR system. More specifically, the present disclosure provides solutions related to managing, in the NR system, a timer used to implement the fast handover failure recovery technology. The present disclosure provides a control method for user equipment and user equipment.

According to a first aspect of the present disclosure, a control method executed in user equipment (UE) is provided, the control method comprising: receiving, by the UE, a radio resource control (RRC) reconfiguration message from a base station; and if the RRC reconfiguration message comprises radio link monitoring configuration information, if a fast handover failure recovery timer is running, stopping the fast handover failure recovery timer.

In the above control method, the fast handover failure recovery timer is a timer T312, and the timer T312 is a timer associated with a measurement configuration corresponding to a cell group, wherein the cell group comprises a master cell group (MCG) and a secondary cell group (SCG).

In the above control method, the radio link monitoring configuration information is an information element rlf-TimerAndConstants. If the received information element rlf-TimerAndConstants is set to “release,” the configuration of the fast handover failure recovery timer is released. If the received information element rlf-TimerAndConstants is not set to “release,” the configuration of the fast handover failure recovery timer is reconfigured according to the received configuration content.

In the above control method, the configuration of the fast handover failure recovery timer refers to a value of the fast handover failure recovery timer and/or an indication configuration indicating whether one or a plurality of measurement identifications (IDs)s can use the fast handover failure recovery timer.

In the above control method, the radio link monitoring configuration information is used for reconfiguration of a reference signal(s) for radio link monitoring (RLM), and the UE reconfigures, on the basis of the received radio link monitoring configuration information, a reference signal(s) used for radio link monitoring.

In the above control method, the UE starts the timer T312 when at least one of the following conditions is met: condition 1, for a measurement ID, if a trigger type is set to “event,” and all measurements of one or a plurality of applicable cells having been filtered by a layer 3 have met, within a time period timetoTrigger, an entry condition applied to the event, and a measurement report list VarMeasReportList stored in the UE does not comprise any measurement report item for the measurement ID, and if the UE supports the timer T312 and the configuration for the event comprises a configuration indicating that the timer T312 is available, a timer T310 is running, and a secondary cell group (SCG) is not configured or one or a plurality of timers T313 are running and the timer T312 is not running, then the timer T312 is started; condition 2, for a measurement ID, if a trigger type is set to “event,” and all measurements of one or a plurality of applicable cells not comprised in a triggered cell list cellsTriggeredList having been filtered by the layer 3 have met, within the time period timetoTrigger, an entry condition applied to the event, and if the UE supports the timer T312 and the configuration for the event comprises a configuration indicating that the timer T312 is available, the timer T310 is running, and a secondary cell group (SCG) is not configured or one or a plurality of timers T313 are running and the timer T312 is not running, then the timer T312 is started; condition 3, for a measurement ID, if a trigger type is set to “event,” if all measurements of one or a plurality of applicable cells comprised in the triggered cell list cellsTriggeredList having been filtered by the layer 3 have met, within the time period timetoTrigger, a leaving condition applied to the event, and if the UE supports the timer T312 and the configuration for the event comprises a configuration indicating that the timer T312 is available, the timer T310 is running, and a secondary cell group (SCG) is not configured or one or a plurality of timers T313 are running and the timer T312 is not running, then the timer T312 is started, wherein the timer T310 is a timer used for MCG radio link failure detection, and the timer T313 is a timer used for SCG radio link failure detection.

According to a second aspect of the present disclosure, a control method executed in user equipment (UE) is provided, the control method comprising: causing the UE and a base station to communicate with each other through dual connectivity (DC) based on a master cell group (MCG) and a secondary cell group (SCG); and if the UE detects an MCG failure or if the UE initiates a procedure for transmitting an MCG failure information message, if a fast handover failure recovery timer is running, stopping the fast handover failure recovery timer.

In the above control method, the fast handover failure recovery timer is a timer T312, and the MCG failure comprises the following: a radio link failure (RLF) occurs in the MCG; an RRC configuration of the MCG fails; integrity monitoring for the MCG fails; a maximum uplink transmission timing difference is exceeded.

According to a third aspect of the present disclosure, user equipment (UE) is provided, the user equipment comprising: a processor; and a memory, stored with instructions, wherein when executed by the processor, the instructions execute the control method described herein.

### BRIEF DESCRIPTION OF THE DRAWINGS

In order to understand the present disclosure and advantages thereof more fully, reference will now be made to the following description made in conjunction with the accompanying drawings.

FIG. 1 shows a handover procedure in an LTE/NR system;

FIG. 2 shows an example of a timing relationship between timing of a timer T310 and a handover command;

FIG. 3 shows a flowchart of a control method 100 for user equipment (UE) according to an embodiment of the present disclosure;

FIG. 4 shows a flowchart of a control method 200 for user equipment (UE) according to an embodiment of the present disclosure; and

FIG. 5 shows a block diagram of user equipment 300 according to an embodiment of the present disclosure.

In the drawings, identical or similar structures are marked by identical or similar reference numerals.

### DETAILED DESCRIPTION

According to the following detailed description of exemplary embodiments of the present disclosure made in conjunction with the accompanying drawings, other aspects, advantages, and prominent features of the present disclosure will become apparent to those skilled in the art.

In the present disclosure, the terms “include” and “comprise” and derivatives thereof mean inclusion without limitation; the term “or” may have an inclusive meaning and means “and/or.”

In the present specification, the following various embodiments for describing the principles of the present disclosure are merely illustrative, and should not be interpreted in any way as limiting the scope of the disclosure. The following description with reference to the accompanying drawings is used to facilitate full understanding of the exemplary embodiments of the present disclosure defined by the claims and equivalents thereof. The following description includes a variety of specific details to facilitate understanding, but these details should be considered merely exemplary. Therefore, those of ordinary skill in the art should recognize that various changes and modifications may be made to the embodiments described herein without departing from the scope and spirit of the present disclosure. In addition, the description of the known function and structure is omitted for clarity and simplicity. In addition, the same reference numerals are used for similar functions and operations throughout the accompanying drawings.

A plurality of embodiments according to the present disclosure are specifically described below by using an LTE/NR mobile communication system and subsequent evolved versions thereof as an exemplary application environment. However, it is to be noted that the present disclosure is not limited to the following embodiments, but may be applied to other wireless communications systems. In the present disclosure, unless otherwise specified, the concept of a cell and the concept of a base station are interchangeable. An LTE system may also refer to a 5G LTE system and a post-5G LTE system (such as an LTE system referred to as an eLTE system or an LTE system that can be connected to a 5G core network). In addition, the LTE can be replaced with an evolved universal terrestrial radio access network (E-UTRAN) or an evolved universal terrestrial radio access (E-UTRA).

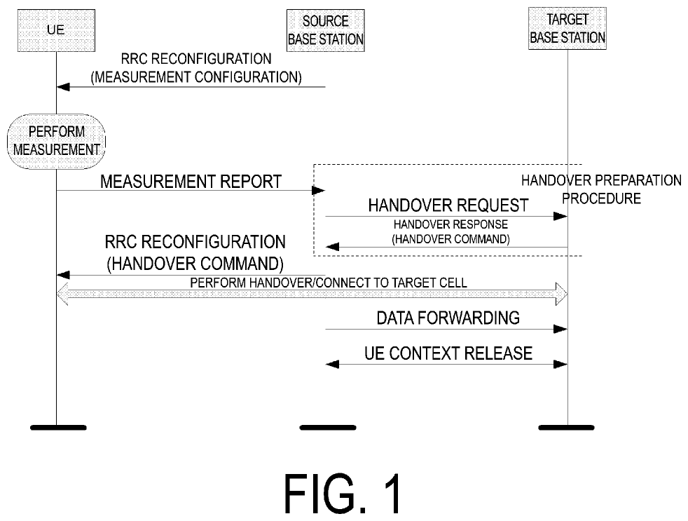

Firstly, a handover procedure in an LTE/NR system is briefly described. FIG. 1 shows the handover procedure in the LTE/NR system. As shown in FIG. 1, a serving base station (also referred to as a source base station during handover) of UE triggers radio resource management measurement of the UE by transmitting a measurement configuration to the UE. Measurement used for the purpose of handover generally has a trigger type configured to be an event. When a measurement result of measurement performed by the UE on a measurement object (such as a measured target carrier frequency or a measured serving cell/neighboring cell) meets a threshold for measurement reporting for longer than a certain time period, the UE triggers the measurement reporting, and transmits a measurement report to the base station. After receiving the measurement report, the base station evaluates the measurement result in the measurement report, and if the base station considers that a handover is needed, then the base station selects a target base station to initiate a handover preparation procedure. After completion of the handover preparation procedure, the target base station generates RRC reconfiguration messages including in-synchronization reconfiguration Reconfigurationwithsync or mobility control information MobilityControllnformation, and delivers the same to the UE through the source base station. After receiving the RRC reconfiguration messages, the UE starts to perform handover, and is synchronized with the target base station. When the UE is successfully connected to the target base station through a random access procedure, the UE considers that the handover procedure is successfully completed.

In the above procedure, the “certain time period” is configured by a network side, and is referred to as trigger time TimeToTigger.

It should be noted that in the present disclosure, the above RRC reconfiguration messages including an information element of in-synchronization reconfiguration Reconfigurationwithsync or an information element of mobility control information MobilityControllnfo are collectively referred to as a handover command, and the handover command is used to trigger the UE to perform network side-controlled mobility. The information element of in-synchronization reconfiguration or the information element of mobility control information includes configuration information of the target base station, and is used to configure mobility information, such as the configuration information of the target base station, to the UE during the network side-controlled mobility. In the present disclosure, the handover generally refers to a handover controlled by a network layer or the UE, cell change, an intra-cell handover used for security update, etc. performed in an RRC connected state.

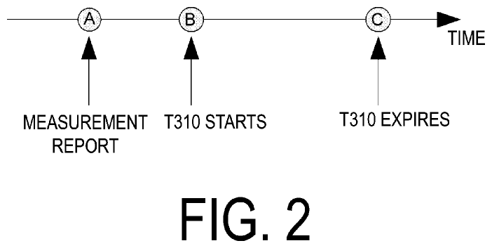

Secondly, a fast handover failure recovery mechanism in the LTE is described. A research on mobility enhancements of LTE Release 12 shows that one of the main reasons for a handover failure is that a radio link failure (RLF) occurs before the UE can receive any handover command in time after transmitting the measurement report. For example, FIG. 2 shows an example of a timing relationship between timing of a timer T310 and a handover command. As shown in FIG. 2, the UE triggers a measurement report used for handover at a time point A. At a time point B, the UE receives N310 consecutive out-of-sync indications from a physical layer, and starts the timer T310. When the T310 expires at a time point C, if the UE has not received any handover command, then the UE considers that an RLF occurs, and triggers an RRC re-establishment procedure to recover an RRC connection. This means that in this handover failure procedure, a service interruption time period of the UE is at least the time length of the T310. When the T310 is running, downlink quality of the UE is extremely poor. It is generally believed that the UE cannot receive any handover command in this case, and waiting for a handover command during the entire operation time period of the T310 is not beneficial. In order to reduce the service interruption time period in this case, an early expiry mechanism for T310 is introduced to the LTE system, that is, a timer T312 is introduced. The operation of the T312 reduces the service interruption time period during the handover, so that the UE can quickly trigger an RRC connection re-establishment procedure to recover an RRC connection between the UE and the network side, thereby achieving fast handover failure recovery.

The above T310 is defined in the LTE/NR system, and is used for radio link failure detection. Specifically, when a physical layer problem of a primary cell Pcell is detected, namely, when N310 consecutive out-of-sync indications are received from a lower layer, the T310 is started. When N311 in-sync indications from the lower layer for the primary cell Pcell are received, or when the handover procedure is triggered, or when the RRC connection re-establishment procedure is initiated, the timer T310 is stopped. If the T310 expires, and if security has not been activated, then the UE leaves the RRC connected state and enters into an RRC idle state; or otherwise, if the security has been activated, then the RRC connection re-establishment procedure is triggered.

N310/N311 are constants, and are configured by the network side. If the network side does not configure the constants, then the UE uses a predefined default value.

In a current LTE technical specification protocol, as described above, the T312 is used for radio link failure detection when the measurement report used for handover is triggered. Generally, the value is set to be a value less than the T310 so as to achieve fast radio link failure detection and fast handover failure recovery. When a measurement report is triggered for a measurement ID configured with the T312, and when the T310 is running, the T312 is started. When the N311 consecutive in-sync indications from the lower layer are received, or when the UE initiates the handover procedure, or when the UE initiates the RRC connection re-establishment procedure, or when the T310 expires, the running T312 is stopped. If the T312 expires and the security has not been activated, then the UE enters into the RRC idle state; or otherwise, if the T312 expires and the security has been activated, then the RRC connection re-establishment procedure is initiated. More specifically, the T312 is started when one of the following conditions is met:

Condition 1, for a measurement ID, if a trigger type is set to “event,” and all measurements of one or a plurality of applicable cells having been filtered by a layer 3 have met, within a time period timetoTrigger, an entry condition applied to the event, and a measurement report list VarMeasReportList stored in the UE does not include any measurement report item for the measurement ID, and if the UE supports the T312 and the configuration for the event includes a configuration (an information element useT312) indicating that the T312 is available, and if the T310 is running, and if the T312 is not running, then the T312 is started.

Condition 2, for a measurement ID, if a trigger type is set to “event,” and all measurements of one or a plurality of applicable cells not included in a triggered cell list cellsTriggeredList having been filtered by the layer 3 have met, within the time period timetoTrigger, an entry condition applied to the event, and if the UE supports the T312 and the configuration for the event includes a configuration (the information element useT312) indicating that the T312 is available, and if the T310 is running, and if the T312 is not running, then the T312 is started.

Condition 3, for a measurement ID, if a trigger type is set to “event,” and all measurements of one or a plurality of applicable cells included in the triggered cell list cellsTriggeredList having been filtered by the layer 3 have met, within the time period timetoTrigger, a leaving condition applied to the event, and if the UE supports the T312 and the configuration for the event includes a configuration (the information element useT312) indicating that the T312 is available, and if the T310 is running, and if the T312 is not running, then the T312 is started.

It should be noted that the present disclosure does not limit a starting scenario of the above T312. For example, the T312 may also be started when the measurement report for a measurement ID has been successfully transmitted to the base station. However, when an RLF occurs subsequently and the T310 is therefore started, if the measurement ID is configured with the T312, then the T312 is started.

Some new mechanisms with respect to the LTE system have been introduced or are to be introduced to the NR system. For example, a beam technology using high-frequency resources is widely used in NR systems, and different reference signals and the like are configured to implement the beam technology. For example, in a fast master cell group (MCG) link recovery mechanism in dual connectivity (DC), a configured secondary cell group (SCG) link is used to perform fast recovery for a master cell group link (a signaling radio bearer 1 (SRB1)) and the RRC connection. The following embodiments of the present disclosure provide, mainly with respect to some new mechanisms introduced in NR, a timer T312 management method used for fast handover failure recovery.

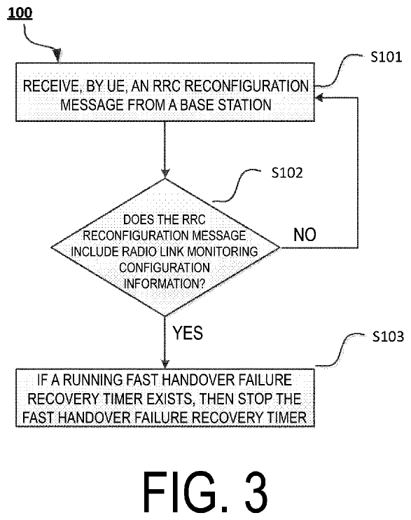

The control method for user equipment (UE) in the present disclosure is described below. Specifically, a management method for a timer used to implement fast handover failure recovery technology is described. As an example, FIG. 3 shows a flowchart of a control method 100 for user equipment (UE) according to an embodiment of the present disclosure.

In step S101, the user equipment (UE) receives an RRC reconfiguration message from a base station. Regarding the RRC reconfiguration message, for example, when a source base station considers that a handover needs to be performed for the user equipment (UE), the source base station selects a target base station to initiate a handover preparation procedure. After completion of the handover preparation procedure, the target base station generates RRC reconfiguration messages including in-synchronization reconfiguration Reconfigurationwithsync or mobility control information MobilityControllnformation, and delivers the same to the UE through the source base station.

In step S102, whether the received RRC reconfiguration message includes radio link monitoring configuration information is determined.

The above radio link monitoring configuration information may be an information element rlf-TimerAndConstants, or may be information about reconfiguration of a reference signal(s) for radio link monitoring (RLM).

When it is determined in step S102 that the received RRC reconfiguration message includes the radio link monitoring configuration information, step S103 is performed. In step S103, if a fast handover failure recovery timer is running, then the fast handover failure recovery timer is stopped.

When it is determined in step S102 that the received RRC reconfiguration message does not include the radio link monitoring configuration information, step S101 is performed again.

The above fast handover failure recovery timer may be, for example, a timer T312 in a technical specification protocol. The timer T312 may be a timer associated with a measurement configuration corresponding to a cell group. The above cell group may include a master cell group (MCG) and a secondary cell group (SCG).

As described above, for example, when the radio link monitoring configuration information is an information element rlf-TimerAndConstants, and if the information element rlf-TimerAndConstants is set to “release,” then the configuration of the fast handover failure recovery timer (such as the timer T312) is released. On the other hand, if the received information element rlf-TimerAndConstants is not set to “release,” the configuration (such as the configuration of an information element useT312) of the fast handover failure recovery timer (such as the timer T312) is reconfigured according to the received configuration content.

As described above, when the above radio link monitoring configuration information is information about reconfiguration of a reference signal(s) for radio link monitoring (RLM), the user equipment (UE) reconfigures, on the basis of the received information, a reference signal(s) used for radio link monitoring.

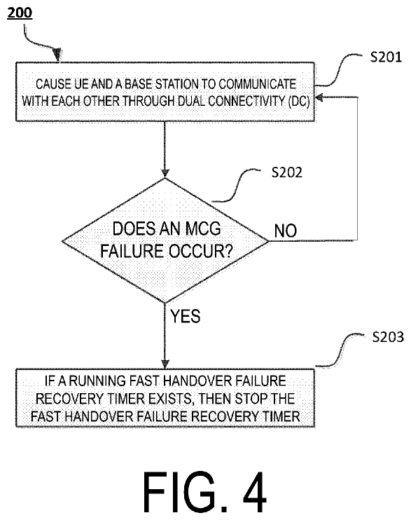

Another control method for user equipment (UE) in the present disclosure is described below. Specifically, another management method for a timer used to implement a fast handover failure recovery technology is described. As an example, FIG. 4 shows a flowchart of a control method 200 for user equipment (UE) according to an embodiment of the present disclosure.

In step S201, the user equipment (UE) and a base station are caused to communicate with each other through dual connectivity (DC) based on a master cell group (MCG) and a secondary cell group (SCG).

In step S202, the user equipment (UE) determines whether an MCG failure occurs. If it is determined in step S202 that an MCG failure occurs, then step S203 is performed. In step S203, if a fast handover failure recovery timer is running, then the fast handover failure recovery timer is stopped.

If it is determined in step S202 that no MCG failure occurs, step S201 is performed again to continue communication with the base station.

The above MCG failure may be, for example, as follows: a radio link failure (RLF) occurs in the MCG; an RRC configuration of the MCG fails (for example, an RRC reconfiguration fails); integrity monitoring of the MCG fails; a maximum uplink transmission timing difference is exceeded, etc.

The running fast handover failure recovery timer may be stopped when an MCG failure is detected, or the running fast handover failure recovery timer may be stopped when a procedure for transmitting an MCG failure information message is initiated.

The above fast handover failure recovery timer may be, for example, a timer T312 in a technical specification protocol.

Specific embodiments of the present disclosure are described in detail below. In addition, as described above, the embodiments of the present disclosure are exemplary descriptions for facilitating understanding of the present invention, and are not intended to limit the present invention.

### Embodiment 1

This embodiment provides a management method for a timer T312. This embodiment avoids an unnecessary RRC connection re-establishment procedure and subsequent service interruption due to inappropriate expiry of the T312. The above management method includes the following steps:

Step 1, UE receives an RRC reconfiguration message from a base station.

Step 2, if the RRC reconfiguration message includes an information element rlf-TimerAndConstants, then the UE performs one or a plurality of the following operations to configure an RLF-related timer and constant corresponding to the cell group:

if the received information element rlf-TimerAndConstants is set to “release,”
if a T312 is running, then stop the T312;
release a configuration of the T312, that is, a value of the T312 and/or an indication configuration (a configuration of an information element useT312) indicating whether one or a plurality of measurement IDs can use the T312 are released;

otherwise, that is, if the received information element rlf-TimerAndConstants is not set to “release,”
if a T312 is running, then stop the T312;
reconfigure the T312 in accordance with the received configuration content, that is, the value of the T312 and/or the indication configuration (the configuration of the information element useT312) indicating whether one or a plurality of measurement IDs can use the T312 are reconfigured.

The information element rlf-TimerAndConstants is used to configure, for a cell group, timers and constants used for detecting and triggering a cell-level radio link failure.

The above measurement ID may also refer to a measurement report configuration reportconfig corresponding to the measurement ID or a report configuration ID ReportConfigld corresponding to the measurement report configuration. Alternatively, the above measurement ID may also refer to a measurement object configuration corresponding to the measurement ID or a measurement object ID MeasObjectld corresponding to the measurement object configuration.

The above T312 may refer to a T312 associated with a measurement configuration corresponding to or associated with the cell group, and may also refer to a T312 associated with the measurement configuration corresponding to the cell group including an MCG and an SCG.

Preferably, the information element rlf-TimerAndConstants is included in an information element SpCellConfig. The information element SpCellConfig is used to configure parameters, such as serving cell-specific media access control layer parameters and physical layer parameters, for a special cell SpCell of a cell group (the MCG or the SCG) of the UE. In dual connectivity (DC) configuration, the SpCell refers to a primary cell of the MCG or a primary secondary cell PSCell of the SCG. Otherwise, in a scenario in which the DC is not configured, the SpCell refers to a primary cell PCell. A SpCell supports physical uplink control channel (PUCCH) transmission and contention-based random access, and is always in an active state.

### Embodiment 2

This embodiment provides a management method for a timer T312. This embodiment avoids an unnecessary RRC connection re-establishment procedure and subsequent service interruption due to inappropriate expiry of the T312. The above management method includes the following steps:

Step 1, UE receives an RRC reconfiguration message from a base station.

Step 2, if the RRC reconfiguration message includes reconfiguration information of any reference signal(s) used for radio link monitoring (RLM), if a T312 is running, then the UE stops the T312.

Preferably, the reference signal configuration information used for RLM is included in an information element spCellConfigDedicated in an information element SpCellConfig. In this case, step 2 can be further described as follows: if the information element SpCellConfig in the RRC reconfiguration message includes the information element spCellConfigDedicated, and if any reference signal(s) used for RLM are reconfigured in the received information element spCellConfigDedicated, and if a T312 is running, then stop the T312. The information element SpCellConfig is used to configure parameters, such as serving cell-specific media access control layer parameters and physical layer parameters, of a special cell SpCell of a cell group (an MCG or an SCG) of the UE. The information element spCellConfigDedicated is relative to common spCell configuration information, and is used to configure serving cell-dedicated parameters for a special cell of a cell group (the MCG or the SCG). The configuration is mostly UE-dedicated configuration, such as a bandwidth part configuration, uplink configuration, timing advance group ID, etc.

In dual connectivity (DC) configuration, the SpCell refers to a primary cell of the MCG or a primary secondary cell PSCell of the SCG. Otherwise, in a scenario in which the DC is not configured, the SpCell refers to a primary cell PCell. A SpCell supports physical uplink control channel (PUCCH) transmission and contention-based random access, and is always in an active state.

Preferably, the above T312 may refer to a T312 associated with a measurement configuration corresponding to or associated with the cell group. Alternatively, the above T312 may also refer to a T312 associated with the measurement configuration corresponding to the cell group including the MCG and the SCG.

The statement “used for RLM” can also be described as used for detecting a beam failure or detecting a cell radio link failure.

### Embodiment 3

This embodiment provides a management method for a timer T312. This embodiment avoids an unnecessary RRC connection re-establishment procedure and subsequent service interruption due to inappropriate expiry of the T312.

In this embodiment, UE performs the following operations:

Step 1, stop a timer T310.

Step 2, stop a timer T312.

This embodiment is used to achieve that the UE stops the function of the T312 when the T310 is stopped. In the other words, if the T310 is stopped, then the T312 is stopped.

### Embodiment 4

This embodiment provides a management method for a T312. Preferably, the method can be applied to a DC scenario. The DC may refer to various combinations in which a primary base station is LTE or NR and a secondary base station is LTE or NR (such as NE-DC in which the primary base station is NR and the secondary base station is LTE). This embodiment avoids an unnecessary RRC connection re-establishment procedure and subsequent service interruption due to inappropriate expiry of the T312.

When UE detects an RLF used for an MCG, the T312 is stopped.

Preferably, the above UE operation is performed when the UE activates or configures fast MCG failure recovery (or referred to as an MCG failure information report procedure or a configuration related to the MCG failure information report procedure).

### Embodiment 5

This embodiment provides a management method for a T312. Preferably, the method can be applied to a DC scenario. The DC may refer to various combinations in which a primary base station is LTE or NR and a secondary base station is LTE or NR (such as NE-DC in which the primary base station is NR and the secondary base station is LTE). This embodiment avoids an unnecessary RRC connection re-establishment procedure and subsequent service interruption due to inappropriate expiry of the T312.

When UE initiates a procedure for transmitting an MCG failure information message, the T312 is stopped.

The procedure for transmitting the MCG failure information message can be briefly referred to as an MCG failure information messaging procedure, and is used to inform a network side that the UE encounters an MCG failure. The MCG failure may refer to the following: an MCG RLF occurs; an RRC configuration of the MCG fails (for example, an RRC reconfiguration fails); integrity monitoring of the MCG fails; a maximum uplink transmission timing difference is exceeded. Preferably, the MCG failure information messaging procedure is used to report the MCG failure to a base station when the MCG is not suspended.

Preferably, the above UE operation is performed when the UE activates or configures fast MCG failure recovery (or referred to as an MCG failure information report procedure or a configuration related to the MCG failure information report procedure).

### Embodiment 6

This embodiment provides a management method for a T312 in a DC scenario. The DC may refer to various combinations in which a primary base station is LTE or NR and a secondary base station is LTE or NR (such as NE-DC in which the primary base station is NR and the secondary base station is LTE).

In this embodiment, UE starts the T312 when one or a plurality of the following conditions are met.

Condition 1, for a measurement ID, if a trigger type is set to “event,” and all measurements of one or a plurality of applicable cells having been filtered by a layer 3 have met, within a time period timetoTrigger, an entry condition applied to the event, and if a measurement report list VarMeasReportList stored in the UE does not include any measurement report item for the measurement ID, and if the UE supports the T312 and the configuration for the event includes a configuration (an information element useT312) indicating that the T312 is available, and if the T310 is running, and if an SCG is not configured or one or a plurality of T313s are running and the T312 is not running, then the T312 is started.

Condition 2, for a measurement ID, if a trigger type is set to “event,” and all measurements of one or a plurality of applicable cells not included in a triggered cell list cellsTriggeredList having been filtered by the layer 3 have met, within the time period timetoTrigger, an entry condition applied to the event, and if the UE supports the T312 and the configuration for the event includes a configuration (the information element useT312) indicating that the T312 is available, and if the T310 is running, and if an SCG is not configured or one or a plurality of T313s are running and the T312 is not running, then the T312 is started.

Condition 3, for a measurement ID, if a trigger type is set to “event,” and all measurements of one or a plurality of applicable cells included in a triggered cell list cellsTriggeredList having been filtered by the layer 3 have met, within the time period timetoTrigger, a leaving condition applied to the event, and if the UE supports the T312 and the configuration for the event includes a configuration (the information element useT312) indicating that the T312 is available, and if the T310 is running, and if an SCG is not configured or one or a plurality of T313s are running and the T312 is not running, then the T312 is started.

The above T310 refers to a timer used for MCG radio link failure detection, and the T313 refers to a timer used for SCG radio link failure detection. The use of the T313 distinct from the T310 in the present disclosure is for ease of description. However, considering that all timers used for MCG or SCG radio link failure detection are referred to as a T310 in current NR technical specification documents (such as 38.331), in this case, the above T310 is further described as a T310 used for the MCG, and the T313 is described as a T310 used for the SCG for distinction.

Preferably, the above UE operation is performed when the UE activates or configures fast MCG failure recovery (or referred to as an MCG failure information report procedure or a configuration related to the MCG failure information report procedure).

The above embodiments 4, 5, and 6 are applied to a scenario in which fast MCG failure recovery is configured. The fast MCG failure recovery refers to that in the DC scenario, if an MCG failure occurs (and if the MCG is not suspended), then the UE does not trigger an RRC connection re-establishment procedure to recover connection to the network side, and instead, the UE reports the MCG failure to the network side through an SRB of an SCG link. The procedure in which the UE side reports the MCG failure to the network side is the above MCG failure information messaging procedure. A secondary base station of the SCG delivers the received MCG failure information to a primary base station of the MCG, so that the primary base station determines how to recover the RRC connection. For example, an RRC reconfiguration message is transmitted to the UE to reconfigure a relevant RRC parameter, or a handover command is transmitted to the UE to initiate a handover procedure. Alternatively, if an MCG failure occurs and the MCG has been suspended, then the UE still triggers the RRC connection re-establishment procedure to recover the connection to the network side. Alternatively, if an MCG failure occurs and the MCG has been suspended for longer than a time period, or if the UE has transmitted the MCG failure information message to the SCG for longer than a time period, and if the MCG failure has not recovered during this time period (such as a radio connection recovery triggered by not receiving N311 consecutive in-sync indications from a lower layer), then the UE still triggers the RRC connection re-establishment procedure to recover the connection to the network side. The time period may be pre-defined, or may be configured through the base station.

### Embodiment 7

This embodiment provides a management method for a T312. This method can implement fast handover failure recovery after a measurement report has been reported to a network side, so that a service interruption time period caused by T310-based link failure monitoring is reduced. The management method includes the following steps:

Step 1, UE detects a physical layer problem in an RRC connected state, that is, N310 consecutive out-of-sync indications are received from a lower layer.

Step 2, if a measurement report is transmitted within a past time period (denoted as T) for a measurement ID configured to use a T312, then start the T312. The value of the T may be predefined such as n milliseconds, or may be configured by a base station.

### Embodiment 8

This embodiment provides a management method for a T312. This method can implement fast handover failure recovery after a measurement report has been reported to a network side, so that a service interruption time period caused by T310-based link failure monitoring is reduced. The management method includes the following steps:

Step 1, UE starts a T310.

Step 2, if a measurement report is transmitted within a past time period (denoted as T) for a measurement ID configured to use a T312, then start the T312. The value of the T may be predefined such as n milliseconds, or may be configured by a base station.

### Embodiment 9

This embodiment provides a management method for a T312. This method can stop the T312 in the above conditions, so that an RRC connection re-establishment caused by inappropriate expiry of the T312 is avoided. The management method includes the following steps:

Step 1, UE receives an RRC reconfiguration message.

Step 2, if the RRC connection reconfiguration message includes a reconfiguration of a T312 configured for one or a plurality of measurement objects in a measurement configuration, then the UE performs one or a plurality of the following operations:
For one or a plurality of associated measurement objects, if a T312 is running, then stop the T312.
reconfigure the T312 in accordance with the received configuration content, that is, the value of the T312 and/or the indication configuration (the configuration of the information element useT312) indicating whether one or a plurality of measurement IDs can use the T312 are reconfigured.

The one or a plurality of measurement objects can also be replaced with one or a plurality of measurement IDs.

It should be noted that the present disclosure uses the name of the timer T312 used in the fast handover failure recovery mechanism in the LTE system. However, the present disclosure does not limit the name of the timer, and the timer can also be named as, for example, Txxx and the like.

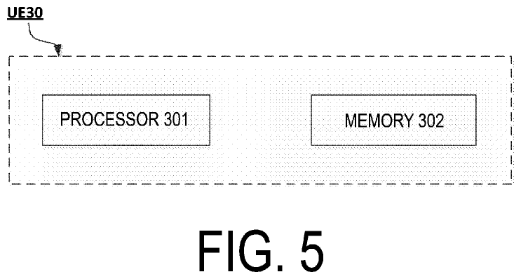

FIG. 5 shows a block diagram of user equipment 30 according to an embodiment of the present disclosure. As shown in FIG. 5, the user equipment 30 includes a processor 301 and a memory 302. The processor 301 may include, for example, a microprocessor, a microcontroller, an embedded processor and so on. The memory 302 may include, for example, a volatile memory (for example, a random access memory (RAM)), a hard disk drive (HDD), a non-volatile memory (for example, a flash memory), or other memory systems. Program instructions are stored on the memory 302. When executed by the processor 301, the instructions can perform the aforementioned control method in the user equipment as described in detail in the present disclosure.

In the present application, the term “base station” refers to a mobile communication data and control switching center with a larger transmit power and a wider coverage area, and has functions of resource distribution scheduling, data receiving and transmitting, and the like. The term “user equipment” refers to a user mobile terminal, for example, a terminal device capable of performing wireless communication with a base station or a micro base station, including a mobile phone, a notebook computer and the like.

The methods and related devices according to the present disclosure have been described above in conjunction with preferred embodiments. It should be understood by those skilled in the art that the methods shown above are only exemplary. The method according to the present disclosure is not limited to steps or sequences shown above. The base station and user equipment shown above may include more modules. For example, the base station and user equipment may further include modules that may be developed or will be developed in the future to be applied to a base station, an MME, or UE. Various identifiers shown above are only exemplary, not for limitation, and the present disclosure is not limited to specific information elements serving as examples of these identifiers. Those skilled in the art can make various alterations and modifications according to the teachings of the illustrated embodiments.

The program running on the device according to the present disclosure may be a program that enables a computer to implement the functions of the embodiments of the present disclosure by controlling a central processing unit (CPU). The program or information processed by the program can be stored temporarily in a volatile memory (e.g., Random Access Memory (RAM)), a Hard Disk Drive (HDD), a non-volatile memory (e.g., flash memory), or other memory systems.

The program for implementing the functions of the embodiments of the present disclosure may be recorded on a computer-readable recording medium. The corresponding functions can be achieved by reading programs recorded on the recording medium and executing these programs by the computer system. The so-called “computer system” may be a computer system embedded in the device, which may include operating systems or hardware (e.g., peripherals). The “computer-readable recording medium” may be a semiconductor recording medium, an optical recording medium, a magnetic recording medium, a short-time dynamic memory program, or any other recording medium readable by a computer.

Various features or functional modules of the device used in the foregoing embodiments may be implemented or executed by circuits (e.g., monolithic or multi-chip integrated circuits). Circuits designed to execute the functions described in this description may include general-purpose processors, Digital Signal Processors (DSPs), Application Specific Integrated Circuits (ASICs), Field Programmable Gate Arrays (FPGAs) or other programmable logic devices, discrete gates or transistor logic, or discrete hardware components, or any combination of the above. The general-purpose processor may be a microprocessor, or may be any existing processor, a controller, a microcontroller, or a state machine. The circuit may be a digital circuit or an analog circuit. When new integrated circuit technologies that replace existing integrated circuits emerge because of the advances in semiconductor technology, one or a plurality of embodiments of the present disclosure may also be implemented using these new integrated circuit technologies.

Furthermore, the present disclosure is not limited to the embodiments described above. Although various examples of the described embodiments have been described, the present disclosure is not limited thereto. Fixed or non-mobile electronic devices mounted indoors or outdoors, such as AV equipment, kitchen equipment, cleaning equipment, air conditioner, office equipment, vending machines, and other household appliances, may be used as terminal devices or communications devices.

The embodiments of the present disclosure have been described in detail above with reference to the accompanying drawings. However, the specific structures are not limited to the above embodiments. The present disclosure also includes any design modifications that do not depart from the substance of the present disclosure. In addition, various modifications may be made to the present disclosure within the scope of the claims. Embodiments resulted from the appropriate combinations of the technical means disclosed in different embodiments are also included within the technical scope of the present disclosure. In addition, components with the same effect described in the above embodiments may be replaced with one another.

1-10. (canceled)

11. A User Equipment (UE) comprising:
receiving circuitry configured to receive a first RRC reconfiguration message including a first information element (IE); and
configuring circuitry configured to stop a timer T312 if the timer T312 is running and if any of the reference signal(s) that are used for radio link monitoring are reconfigured by the received first IE,
wherein the timer T312 is associated with a measurement configuration corresponding to a cell group,
the timer T312 is started based on a triggering of a measurement report for a measurement identity for which the timer T312 has been configured, and
the first IE is used to configure parameters for a special cell of the cell group and the cell group is either a master cell group (MCG) or a secondary cell group (SCG).

12. The UE according to claim 11, wherein:
the receiving circuitry is configured to receive a second RRC reconfiguration message including a second information element (IE),
the configuring circuitry is configured to stop the timer T312 for a corresponding cell group if the second IE is not set to “release” and if the timer T312 for the corresponding cell group is running, and
the second IE is used to configure timers and constants for detecting and triggering a cell-level radio link failure and the cell group is either the MCG or the SCG.

13. The UE according to claim 11, wherein:
the configuring circuitry is configured to stop the timer T312 upon initiation of an MCG failure information procedure that is used to inform a network that the UE encounters an MCG failure.

14. A base station comprising:
transmitting circuitry configured to transmit a first RRC reconfiguration message including a first information element (IE);
wherein if the timer T312 is running and if any of the reference signal(s) that are used for radio link monitoring are reconfigured by the received first IE, the first IE causes a User Equipment (UE) to stop the timer T312,
the timer T312 is associated with a measurement configuration corresponding to a cell group,
the timer T312 is started based on a triggering of a measurement report for a measurement identity for which the timer T312 has been configured, and
the first IE is used to configure parameters for a special cell of the cell group and the cell group is either a master cell group (MCG) or a secondary cell group (SCG).

15. The base station according to claim 14, wherein:
the transmitting circuitry is configured to transmit a second RRC reconfiguration message including a second information element (IE),
if the second IE is not set to “release” and if the timer T312 for a corresponding cell group is running, the second IE causes the UE to stop the timer T312 for the corresponding cell group, and
the second IE is used to configure timers and constants for detecting and triggering a cell-level radio link failure and the cell group is either the MCG or the SCG.

16. A method at a User Equipment (UE), the method comprising:
receiving a first RRC reconfiguration message including a first information element (IE); and
stopping a timer T312 if the timer T312 is running and if any of the reference signal(s) that are used for radio link monitoring are reconfigured by the received first IE,
wherein the timer T312 is associated with a measurement configuration corresponding to a cell group,
the timer T312 is started based on a triggering of a measurement report for a measurement identity for which the timer T312 has been configured, and
the first IE is used to configure parameters for a special cell of the cell group and the cell group is either a master cell group (MCG) or a secondary cell group (SCG).

17. A method at a base station, the method comprising:
transmitting a first RRC reconfiguration message including a first information element (IE);
wherein if the timer T312 is running and if any of the reference signal(s) that are used for radio link monitoring are reconfigured by the received first IE, the first IE causes a User Equipment (UE) to stop the timer T312,
the timer T312 is associated with a measurement configuration corresponding to a cell group,
the timer T312 is started based on a triggering of a measurement report for a measurement identity for which the timer T312 has been configured, and
the first IE is used to configure parameters for a special cell of the cell group and the cell group is either a master cell group (MCG) or a secondary cell group (SCG).
